(19) United States
(12) Patent Application Publication
(10) Pub. No.: US 2007/0007301 A1
(43) Pub. Date: Jan. 11, 2007

(54) Pill dispensing container elements and methods

(76) Inventors: Jeffrey S. Kaplan, Aurora, CO (US); Brent W. Murray, Longmont, CO (US); Clinton L. Percy, Erie, CO (US)

Correspondence Address: THE LAW FIRM OF HARRIS & BURDICK;HAROLD BURDICK AND ROBERT HARRIS, 6676 GUNPARK DRIVE, SUITE E, BOULDER, CO, 80301, US

(21) Appl. No.: 11/475,579

(22) Filed: Jun. 27, 2006

Related U.S. Application Data
(60) Provisional application No. 60/695,038, filed on Jun. 29, 2005.

(51) Int. Cl. G07F 11/00

(52) U.S. Cl. 221/288

(57) ABSTRACT

A pill dispenser apparatus embodied in a pill container element, and method of dispensing one pill at a time from a container, are disclosed. The user may dispense a pill from the container by inverting the container, rotating the top, and returning the container to its upright position. A pill will then exit the apparatus under the force of gravity via a discharge opening.

### RELATED U.S. PROVISION PATENT APPLICATIONS

This Application claims the benefit of U.S. Provisional Patent Application No. 60/695,038 filed Jun. 29, 2005, this Application including (together with additional disclosure of later conceived embodiment of the invention) all non-repetitive written description and pertinent ones of the drawings of the invention described therein and making claim to the invention therein disclosed.

### FIELD OF THE INVENTION

This invention relates to containment and dispensing of pills, tablets, capsules and the like, and, more particularly, relates to apparatus and methods utilizing an element of the container for such dispensing.

### BACKGROUND OF THE INVENTION

Medicine, candy, and other substances are often manufactured in individual units such as tablets, capsules, pills, or the equivalent thereto, all hereinafter generally referred to as “pills”. A plurality of pills are often packaged in a container comprising an opening sealable with a removable cover. The opening may allow pills to be inserted into the container during packaging as well as allow a user to access the interior of the container to remove one or more pills. The removable cover may be used to seal the opening to prevent the undesired exit of pills from the container, and/or to protect the pills from contaminants outside of the container. By way of example and not of limitation, the container may be shaped like a cylinder or parallelepiped, and the removable cover may include a screw-on or snap-on cover.

There are drawbacks to storing pills in a container with an opening sealable by a removable cover. First, a user frequently encounters difficulty in removing a desired quantity of pills from the container via the container's opening. Because the container will generally contain more pills than the user wishes to remove from the container, the user may have to either invert the container so that pills fall out of it under the force of gravity, or remove pills from the container via one or more fingers or a tool. If the user attempts to remove a specific quantity of pills from the container by inverting it, more or less than the desired quantity of pills will frequently fall out.

Similarly, it is often difficult for the user to remove the desired quantity of pills from the container via one or more fingers or a tool. Therefore, the user will frequently have to engage in a frustrating exercise of placing excess pills back into the container, or attempting to obtain additional pills from the container, when the user initially obtained more or less than the desired quantity of pills from the container.

Second, because storing pills in a container with an opening sealable by a removable cover often leads to a user removing excess pills from the container, there is an increased danger that pills may become lost. If the user removes more than the desired quantity of pills from the container, the excess pills may fall to the floor or another surface and become lost. Due to the frequent high cost and/or difficulty in obtaining replacement pills, it may be highly undesirable for pills to become lost.

Third, storing pills in a container with an opening sealable by a removable cover may increase the likelihood of pills in the container being contaminated by contaminants outside of the container. Because storing pills in a container with an opening sealable by a removable cover may result in a user removing excess pills from the container, there is a danger that excess pills will become contaminated by touching a contaminated surface, such as a floor or the user's hands.

Additionally, there is a danger of pills in a container being contaminated by contaminants outside of the container when the removable cover is not sealing the opening on the container. Because the user may have a difficult time removing a specific quantity of pills from the container, the user may leave the removable cover off the container for a relatively long period time. The user may also forget altogether to replace the removable cover on the container after removing one or more pills from the container.

The drawbacks to storing pills in a container with an opening sealable by a removable cover as discussed above may be amplified when the user suffers from a physical or mental disability. For example, a user with reduced coordination or strength may have greater difficulty than a user with normal coordination or strength in inserting their finger into the container and removing a pill. A user with reduced coordination may also have greater difficulty than a user with normal coordination in removing the desired number of pills from the container by inverting the container. A user with a mental disability may be more likely than a user with normal mental ability to not replace the removable cover on the container after dispensing a pill. Additionally, because pills often comprise medication, a user with a disability may need to take more pills and, therefore, may need to remove pills from the container more frequently than a user without a disability.

Due to drawbacks associated with storing pills in a container with an opening sealable by a removable cover including, but not limited to, the drawbacks discussed above, there exists a need for an apparatus and/or method to replace the removable cover and allow a user to easily dispense one or more pills from the container.

A number of pill dispensers which replace the removable cover have been developed. One representative variety is disclosed in Mehrens et al., U.S. Pat. No. 6,860,403. Mehrans et al patent shows an apparatus which is attached to a container and allows a user to dispense a single pill from the container by inverting the container and pill dispenser combination and rotating an element. Thus, the container and pill dispenser apparatus must be inverted while the user is dispensing a pill.

Another representative variety of pill dispensers is disclosed in Moulding Jr. et al., U.S. Pat. No. 4,460,106. The Moulding Jr. et al. patent shows an apparatus that is attached to a container and allows a user to dispense a single pill of various sizes. A user dispenses a pill by inverting the container and pill dispenser combination to allow one or more pills to fall into an upper disk, returning the container and pill dispenser combination to its upright position, guiding a pill into a slot in the upper disk, and rotating a spring loaded element to dispense a pill into a recess. The user may further have to remove the pill from the recess by tilting the container and pill dispenser combination or by inserting a finger into the recess and maneuvering the pill out of the recess. Thus, the actions the user must take when dispensing a pill include guiding a pill into a slot and twisting an element against a spring's force while using two hands.

Other dispensing devices have been heretofore known and/or utilized, many involving container caps and rotatable elements associated therewith (see, for example, U.S. Pat. Nos. 3,991,908, 3,484,818, 3,601,250, 5,947,329, 4,613,057, 5,520,307, 4,523,694, 3,874,564, 3,759,420, 3,477,561, 2,886,209, and 5,791,515). Such devices have not always proven easy to use (either by the pharmacist or other packager or by the end-user) and have often been unduly complex and/or expensive to manufacture, some requiring dispensing from the container by movement against a return spring's force. Some such devices do not allow a user to dispense a pill from a container without requiring the user to have the container inverted while the pill exits the container.

### SUMMARY OF THE INVENTION

This invention provides pill dispensing apparatus incorporated into pill container elements (such as a container cap) and methods, the container elements being easy to use by both the pharmacist or other packager and the end-user, and being relatively simple and inexpensive to manufacture. The apparatus includes no return springs or the like and delivers the pill to a user only when the container is in the upright position.

The apparatus is attachable to a container intended to store one or more pills. Such combination of the apparatus and container (“combination”) may be used by a user to dispense a pill from the container. In one embodiment, the user dispenses a pill from the combination by inverting the combination, rotating an element of the combination, returning the element to its original position, and returning the combination to its upright position. In a second embodiment, no initial rotation of the element of the combination is required. A pill will then exit the combination under the force of gravity via a discharge chute.

The pill dispensing apparatus defines one element of a pill container for holding a quantity of pills. The apparatus includes a base having first and second oppositely oriented funneling structures defined therein. A first opening provides gravity fed outlet from the first funneling structure and a second opening provides gravity fed outlet from the second funneling structure. The first funneling structure opens to the contained quantity of pills.

A rotatable structure (a cover for example) includes at least a first (and preferably plural) pill acceptor for receiving a gravity fed pill through the first opening. The rotatable structure is rotatably connectable with the base at locating and support structures at both the base and rotatable structure for moving the pill received at the pill acceptor to a position in register with the second funneling structure.

In one preferred embodiment of the apparatus, first and second pill acceptors are defined at an inwardly facing surface of the rotatable structure and are located oppositely one another at each side of the locating structure. The base includes an outer wall having an opening therethrough and an inner volume, the inner volume segmented to provide the first and second side by side oppositely oriented funneling structures. The first funneling structure opens to the pill container and funnels to its outlet opening and the second funneling structure funnels to its opening through the outer wall. By these means the outlet from the first funneling structure is positionable adjacent to the inwardly facing surface of the rotatable cover when the locating means and support means are associated so that the outlet can be selectively brought into register with the pill acceptors when the cover is rotated.

The pill dispensing method of this invention includes the steps of inverting the pill container so that the element is located below the quantity of pills and funneling pills to a pill acceptor. The pill acceptor is rotated to a drop location and the pill container is turned to an upright position so that the pill drops from the pill acceptor. The dropped pill is funneled to an outlet opening at a side of the element.

It is therefore an object of this invention to provide improved pill dispensing apparatus and methods.

It is another object of this invention to provide improved pill dispensing apparatus and methods which are incorporated into pill container elements such as the container cap.

It is still another object of this invention to provide pill dispensing apparatus incorporated into pill container elements and methods that are easy to use by both the pharmacist or other packager and the end-user.

It is yet another object of this invention to provide pill dispensing apparatus incorporated into pill container elements and methods that are relatively simple and inexpensive to manufacture, include no return spring's or the like and deliver the pill to a user when the container is in the upright position.

It is another object of this invention to provide a pill dispensing apparatus defining one element of a pill container for holding a quantity of pills, the apparatus including a base having first and second funneling structures defined therein and oppositely oriented, a first opening providing a gravity fed outlet from the first funneling structure and a second opening providing a gravity fed outlet from the second funneling structure, the first funneling structure configured to open to the contained quantity of pills, and a rotatable structure including at least a first pill acceptor for receiving a gravity fed pill through the first opening, the rotatable structure rotatably connectable with the base for moving a pill received at the pill acceptor to a position in register with the second funneling structure.

It is still another object of this invention to provide a pill dispensing apparatus for dispensing pills from a container, the apparatus including a rotatable cover including locating means for rotatably locating the cover, and first and second pill acceptors defined at an inwardly facing surface thereof, the acceptors located oppositely one another at each side of the locating means, and a base associated with the pill container and including an outer wall having an opening therethrough and an inner volume, the inner volume segmented to provide first and second side by side oppositely oriented funneling structures, the first funneling structure opening to the pill container and funneling to an outlet and the second funneling structure funneling to the opening through the outer wall, the base having support means associatable with the locating means of the rotatable cover for rotatably supporting the rotatable cover, wherein the outlet from the first funneling structure is positionable adjacent to the inwardly facing surface of the rotatable cover when the locating means and support means are associated so that the outlet can be selectively brought into register with the pill acceptors when the cover is rotated.

It is yet another object of this invention to provide a pill dispensing method for dispensing pills through an element of a pill container that holds a quantity of pills, the method comprising inverting the pill container so that the element is located below the quantity of pills, funneling pills to a pill acceptor, rotating the pill acceptor having a pill therein to a drop location, turning the pill container to an upright position so that the pill drops from the pill acceptor, and funneling the dropped pill to an outlet opening at a side of the element.

With these and other objects in view, which will become apparent to one skilled in the art as the description proceeds, this invention resides in the novel construction, combination, and arrangement of parts and method substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a front perspective view of a first embodiment of the pill dispensing apparatus of this invention incorporated into the container closure (cap or lid) attached to a container;

FIG. 2 is an exploded view of the pill dispensing apparatus of FIG. 1;

FIG. 3 is a side plan view of the rotating top of the apparatus of FIG. 1;

FIG. 4 is a sectional view of the rotating top taken along line 4-4 of FIG. 3;

FIG. 5 is a top plan view of the sizing collar of the apparatus of FIG. 1;

FIG. 6 is a bottom perspective view of the sizing collar shown in FIG. 5;

FIG. 7 is a top plan view of the base of the apparatus of FIG. 1;

FIG. 8 is a side plan view of the base shown in FIG. 7;

FIG. 9 is a sectional view of the base taken through section lines 9-9 of FIG. 8;

FIG. 10 is a bottom perspective view of the pill dispensing apparatus of FIG. 1;

FIG. 11 is a sectional view of the apparatus of FIG. 1 showing a pill passing through an opening at the base with the base inverted;

FIG. 12 is a side perspective view of the pill dispensing apparatus of FIG. 1 showing a pill in position at the discharge channel.

FIG. 13 is a perspective view of a second embodiment of the pill dispensing apparatus of this invention incorporated into the container closure of the container;

FIG. 14 is an exploded view of the apparatus of FIG. 13;

FIG. 15 is a sectional view of the apparatus of FIG. 13 taken through section lines 15-15 of FIG. 13; and

FIGS. 16a and 16b are perspective views illustrating use of the apparatus of FIG. 13.

### DESCRIPTION OF THE INVENTION

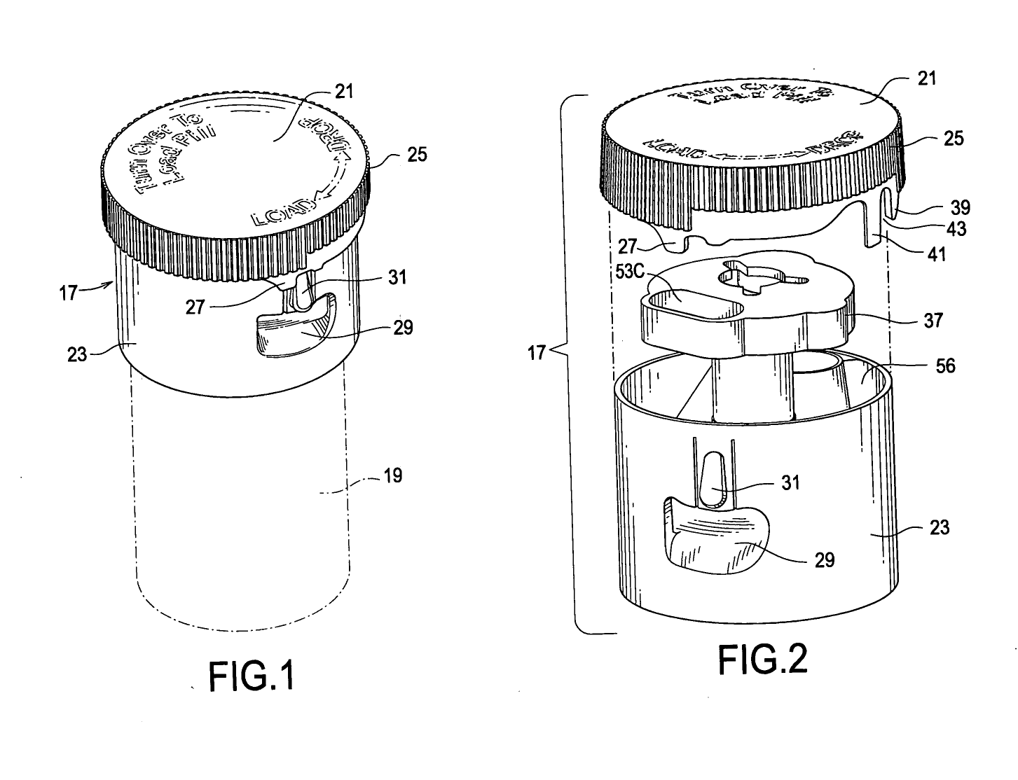

FIGS. 1 through 12 show a first embodiment 17 of the pill dispensing apparatus of this invention configured as and incorporated into a cap attached to container 19. Pill dispensing apparatus 17 includes rotating top 21 and base 23. Base 23 is attachable to container 19. It is to be understood that container 19 is shown by way of example and not of limitation. Container 19 may comprise many shapes and sizes. It is also to be understood that pill dispensing apparatus 17 may be adapted to attach to containers of many shapes and sizes.

Rotating top 21 may include ridges 25 to aid a user in gripping rotating top 21 and/or stop 27 to limit movement of rotating top 21. Base 23 includes discharge shoot (opening) 29 by which a pill exits pill dispensing apparatus 17. Base 23 may include catch button 31 (a depressible tab structure with a protruding portion) to prevent unintended movement of rotating top 21 and/or operation of rotating top 21 by a child.

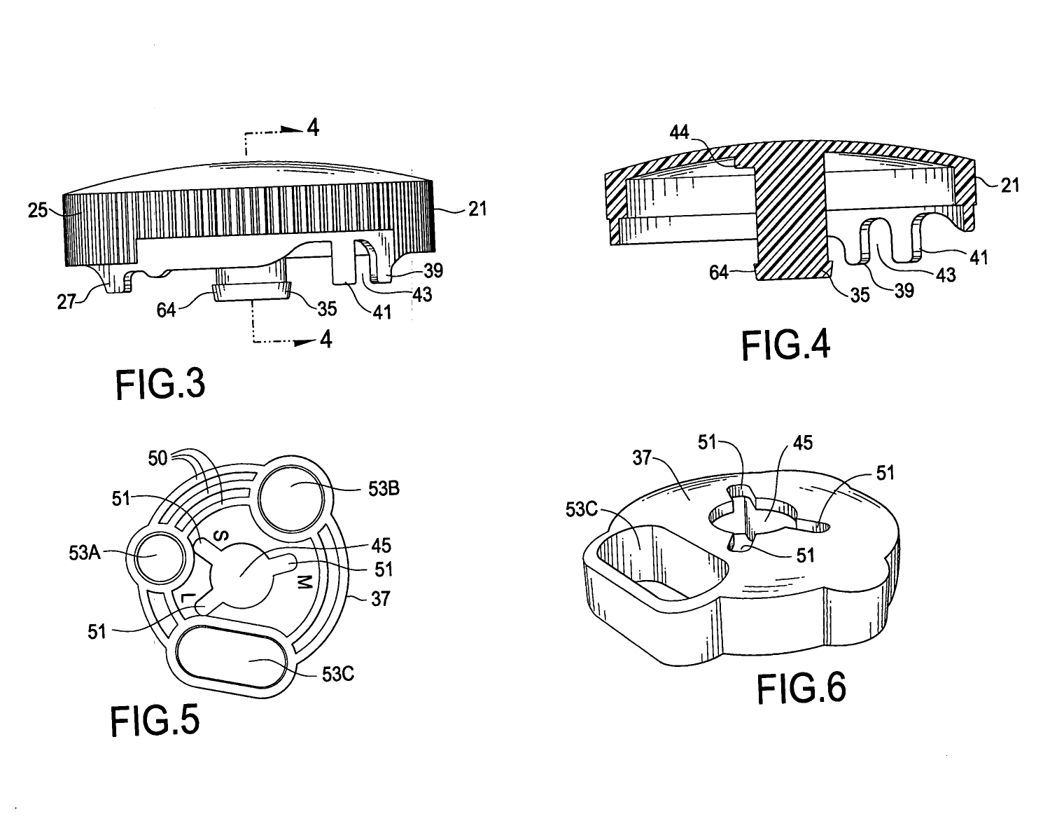

FIGS. 3 and 4 illustrate rotating top 21. Rotating top 21, which forms the outer cover of pill dispensing apparatus 17, is rotatable by a user to select operating positions of pill dispensing apparatus 17. By way of example and not of limitation, one operating position (upright) may be referred to as “drop”, and another operating position (inverted) may be referred to as “load”.

Rotating top 21 includes connector (a shaft) 35 to interface rotating top 21 to base 23. Connector 35 is also used to connect rotating top 21 to sizing collar 37. Rotating top 21 may include catch elements 39 and 41 which capture catch button 31 at detent 43 to prevent unintended movement of rotating top 21 and/or operation of rotating top 21 by a child. Tab 44 locates sizing collar 37 for desired pill size.

FIGS. 5 and 6 better illustrate sizing collar 37. Sizing collar 37 is locatable between rotating top 21 and base 23 in pill dispensing apparatus 17 (see FIGS. 2 and 11). Opening 45 allows sizing collar 37 to be attached to rotating top 21 via connector 35 of rotating top 21. Sizing collar 37 may include support ribs 50 to help support sizing collar 37 and reduce material costs. Sizing collar 37 includes a plurality of pill accepting slot locator openings 51 radiating from opening 45 and configured to capture tab 44 of rotating top 21 to thus select the pill accepting slot size to be used with the particular contents to be loaded into container 19. The number of openings 51 is the same as the number of pill accepting slots (which may vary depending upon the flexibility desired in a particular embodiment). By way of example and not of limitation, a plurality of pill accepting slots of different sizes and/or shapes 53A, 53B and 53C may be used, 53C being shaped for acceptance of a capsule (the term “slot” may include indentations or passages, or both as shown in the FIGURES). Once installed, sizing collar 37 rotates with rotating top 21 to transfer a pill from opening 55 of base 23 to funneling channel 56 (terminating at discharge chute opening 29) of base 23 via a pill accepting slot 53.

Sizing collar 37 may include a plurality of pill accepting slots where each slot is sized and shaped to accommodate a pill of a different predetermined size and/or shape. In this manner, pill dispensing apparatus 17 may be configured to dispense one of the plurality of sizes and/or shapes of pills corresponding to the pill accepting slots of sizing collar 37. Pill dispensing apparatus 17 will dispense a pill of size and shape corresponding to the pill accepting slot that is aligned (prealigned by the individual charged with loading container 19, for example a pharmacist) in communication with opening 55 of base 23 while rotating top 21 is set at the load operating position.

Therefore, a user, pharmacist, manufacturer, or other party may select the size and shape of pill to be dispensed by inserting sizing collar 37 on connector 35 of rotating top 21 with tab 44 at a selected opening 51 such that the pill accepting slot of the desired size and shape of pill is aligned in communication with opening 55 of base 23 while rotating top 21 is set at the load position. For example, if a pharmacist wishes to configure pill dispensing apparatus 17 to dispense pills corresponding in size and shape to pill accepting slot 53B, the pharmacist would mount sizing collar 37 on connector 35 such that pill accepting slot 53B would be aligned in communication with opening 55 of base 23 when rotating top 21 is set at the load position (as shown in FIG. 11).

As shown in the alternative embodiment hereinafter, the pill capture function of slots 53 of sizing collar 37 may be integrated into rotating top 21. Thus, in such embodiment, pill dispensing apparatus 17 may dispense a pill of only one predetermined size.

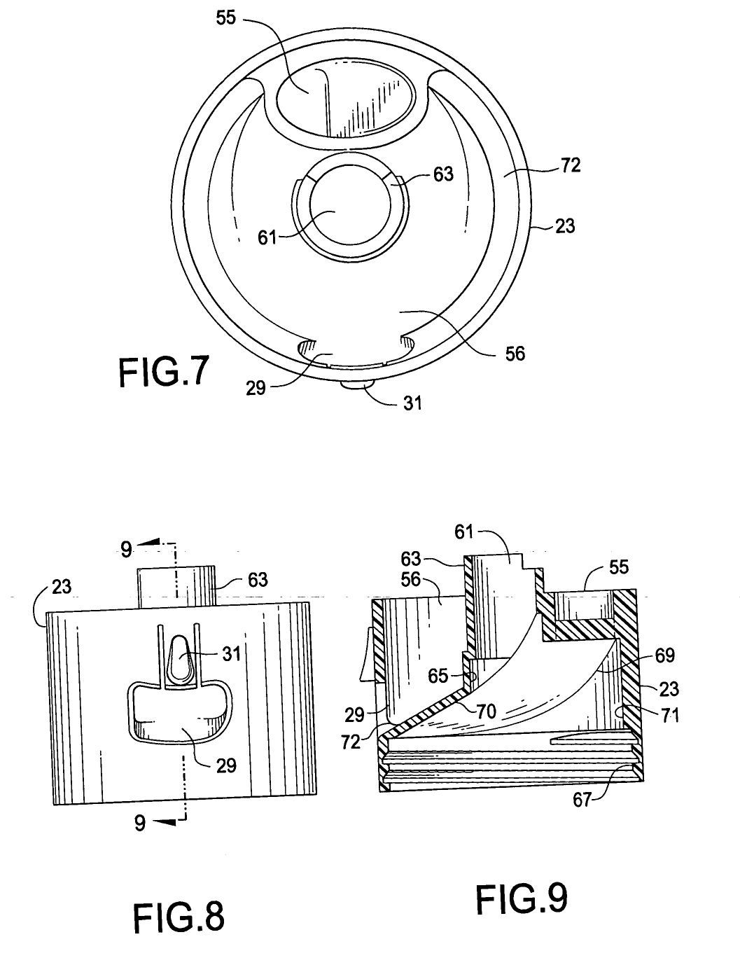

FIGS. 7 through 9 better illustrate base 23. Base 23 is locatable between sizing collar 37 and container 19. Base 23 is interfaceable to rotating top 21 via opening 61 of hollow connector shaft 63 receiving therethrough connector 35 of rotating top 21. Beveled retainer rim 64 at connector 35 and shoulder 65 of shaft 63 allows connector 35 of rotating top 21 to be easily inserted through opening 61 of connector shaft 63 and retained thereat once installed (see FIG. 11).

Base 23 may be integrated into container 19 or may be attachable to container 19. By way of example and not of limitation, base 23 may be attachable to container 19 via threads 67.

Funnel 69 collects pills from container 19 when container 19 is inverted and is defined by divider wall 70 and outer annular wall 71 (which also has opening 29 therethrough). Divider wall 70 is arcuate and segments the inner volume of base 23 into the two funneling structures 56 and 69 each of which function to gravity feed a pill to their respective transfer openings 29 and 55, respectively, depending upon orientation of apparatus 17 (inverted or upright). Opening 55 allows a pill to pass from funnel 69 to sizing collar 37 for transfer to channel 56. Funneling channel 56 (defined by walls 70 and 71) and rounded corner channel 72 guide a pill from a pill accepting slot 53 of sizing collar 37 to discharge chute opening 29 through wall 71.

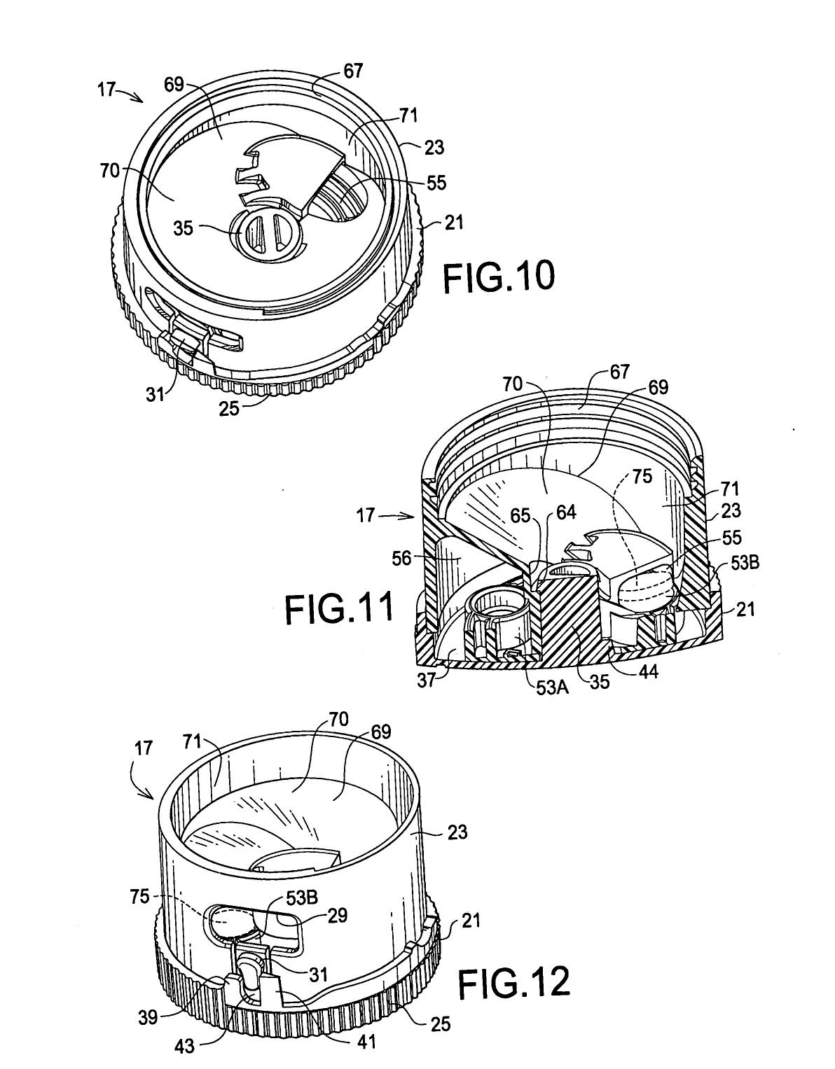

FIGS. 10 through 12 are views showing operation of apparatus 17. A pill 75 passes into opening 55 of base 23 while base 23 is inverted. Once pill 75 passes through opening 55, it will fall into a pill accepting slot 53. Filter barrier 77 helps prevent accumulation and dislodges pills 75 that do accumulate around opening 55 when container 19 and pill dispensing apparatus 17 are inverted.

It is to be understood that container 19 is offered by way of example and not of limitation. Many other containers may be used with pill dispensing apparatus 17. A typical container 19 includes a threaded (or otherwise configured) upper opening which allows pill dispensing apparatus 17 to be attached and secured to container 19 as is known (the connecting structure 67 of base 23 is configured accordingly).

In order to dispense pill 75, a user first insures that pill dispensing apparatus 17 is set in the drop operating position. If pill dispensing apparatus 17 is not set in the drop operating (upright container 19) position, the user twists rotating top 21 from the load operating position to the drop operating position. Pill dispensing apparatus 17 is set in the drop operating position when rotating top 21 is aligned such that catch button 31 is located between catch elements 39 and 41. The user then inverts the pill dispenser apparatus 17 and container 19 combination. One or more pills 75 fall from container 19 into funnel 69 of base 23 under the force of gravity. Once pill 75 falls into funnel 69, funnel 69 directs pill 75 to opening 55. Filter barrier 77 prevents pills from bunching up around opening 55, and helps prevent sizing collar 37 from jamming.

The user then depresses catch button 31 and rotates rotating top 21 clockwise with respect to base 23 while the combination is still inverted until stop 27 hits catch button 31. Optional ridges 25 help the user grasp rotating top 21 during this operation. Pill dispensing apparatus 17 is now set in the load operating position. A pill acceptance slot 53 is aligned with opening 55 and pill 75 falls into pill acceptance slot 53.

While the combination is still inverted, the user rotates rotating top 21 counterclockwise back to the drop operating position. Sizing collar 37 rotates with rotating top 21, and the pill acceptance slot 53 is aligned in communication with funneling channel 56. To complete the pill dispensing process, the user turns the combination upright. Pill 75 is then fed by funneling channel 56 to discharge chute opening 29 under the force of gravity.

To summarize the foregoing embodiment of the apparatus functioning to dispense a pill from a container, the apparatus includes a base attachable to the container, the base having a funnel to collect pills from the container, a first opening functioning to allow a pill to travel from the funnel to a discharge channel, a discharge chute in communication with the discharge channel functioning to eject the pill from the base, and a hollow first shaft. A catch button prevents inadvertent rotation of a rotating top. A sizing collar is attachable to the rotating top and includes three slots each having a different shape and a different size, and an opening permitting the sizing collar to be attached to the rotating top. The rotating top has a shaft for attaching the rotating top to the sizing collar and the base, a catch subsystem functioning to engage the catch button, and a stop subsystem functioning to prevent a user from rotating the rotating top beyond a predetermined amount. The user may discharge a pill from the container when the apparatus is attached to the container by inverting the container, rotating the rotating top until stopped by the stop subsystem, returning the rotating top to its original position, and returning the container to its upright position.

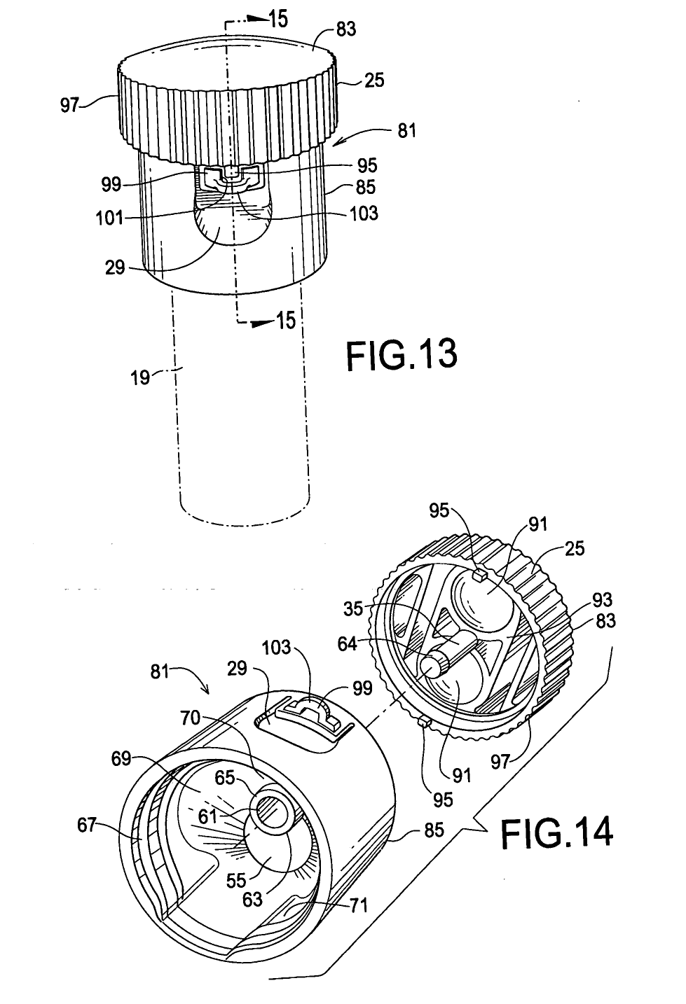

A second embodiment 81 of the pill dispensing container element apparatus of this invention is illustrated in FIGS. 13 through 16, again the apparatus being configured in the pill container closure (or cap). Apparatus 81 includes a rotatable cover (or top) 83 and base 85. As before, cover/top 83 includes ridges 25 to improve grip and central connector shaft 35 or other means for rotatably locating cover/top 83, shaft 35 having beveled retainer rim 64 at one end.

Base 85 includes, as before, is relatively rotatably connected with cover/top 83 at opening 61 of hollow support shaft 63 which receives therethrough connector 35 of cover/top 83 and retains retainer rim 64 against shoulder 65 of shaft 63. Base 23 may be secured to container 19 in any conventional manner, for example using matable threaded surfaces 67. Funnel structure 69 directs pills from container 19 when the container is inverted and is defined by arcuate divider wall 70 and outer annular wall 71 (again also having opening 29 therethrough). Wall 70 segments the inner volume of base 85 into the two side by side and oppositely oriented funneling structures at each side of the wall, structure 69 and funneling channel structure 56 (including channel 72 and defined by walls 70 and 71), each of which function to gravity feed a pill to their respective transfer openings 55 and 29 depending upon orientation of apparatus 81.

Rotatable cover/top 83, however, includes the functionality (in one respect) of sizing collar 37 in so much as it captures and transfers a pill 75 thereat. Each cover/top 83 is selected for engagement with base 85 depending upon the size of pill or capsule 75 to be dispensed, and differently configured cover/tops 83 may be provided as may be appreciated as the description continues.

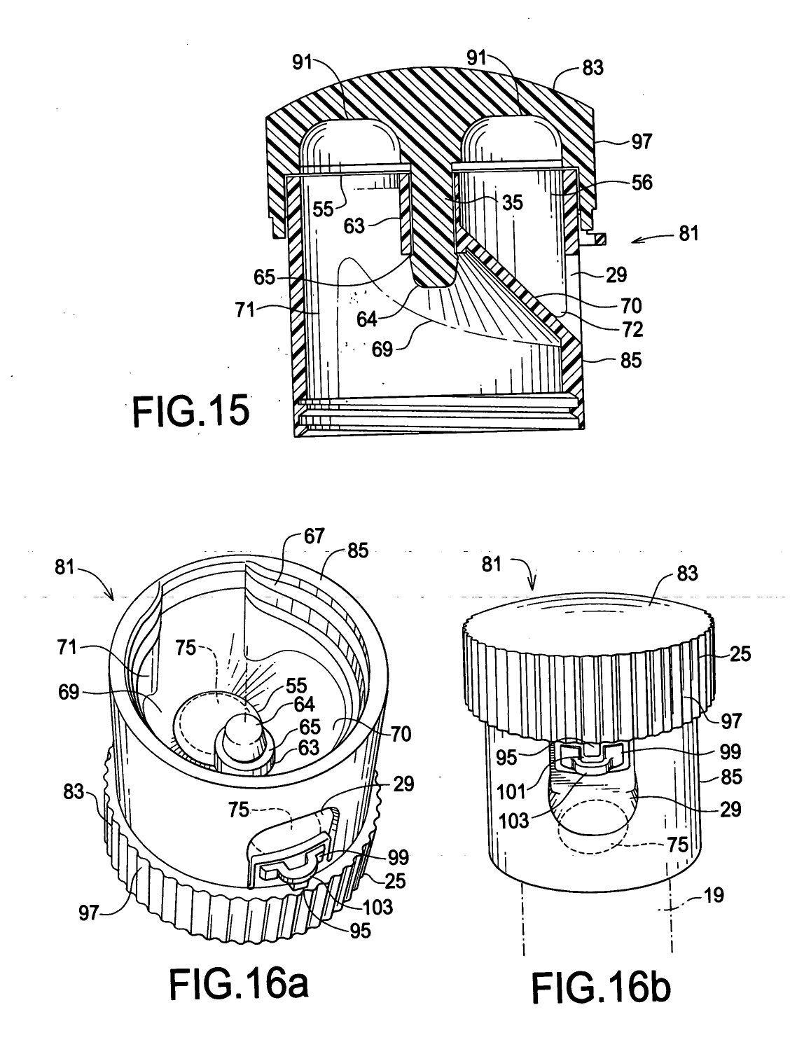

As best viewed in FIGS. 14 and 15, cover/top 83 includes a pair of pill accepting detent structures 91 (corresponding to slots 53 in the prior embodiment) positioned oppositely (circumferentially) at inner annular surface 93 of cover/top 83. Structures 91 are positioned so that one structure 91 comes into register with opening 55 when presented thereat while the other opening 91 at such time is in register with funneling channel structure 56. Tabs 95 are oppositely located along the bottom of outer circumferential wall 97 at locations radially aligned with the center of each structure 91. Outer annular wall 71 and outer circumferential wall 97 are receivable adjacent to one another in a nested relationship. When thus assembled, catch 99 at base 85 adjacent to opening 29 captures a tab 95 when presented thereat in detent 101 to locate and hold structures 91 in correct position. Release of a tab 95 is accomplished by pressure at protrusion 103 (other release mechanisms could be used) during rotation of cover/top 83.

In operation, a tab 95 of cover/top 83 will be held at catch 99. When the container 19/apparatus 81 combination is inverted, gravity feed of pills 75 by funnel structure 69 presents a pill or pills at opening 55 having a pill accepting structure 91 of cover/top 83 in register therewith. A single pill will be received by pill accepting structure 91. While still inverted, a user releases the captured tab 95 and rotates cover/top 83 (in either direction) until the opposite one of tabs 95 is captured at catch 99 (a slight “click” will be heard and/or felt). This will present the pill received by structure 91 at funneling channel structure 56. The user then returns the combination to the upright position which causes pill 75 to be dropped from structure 91 into channel 56 and out through opening 29.

While the apparatus of this invention has been illustrated in association with a container cap or lid, it should be appreciated that the apparatus could be incorporated instead into the container body (at the bottom thereof, for example), and, particularly where the container configuration functions with the cap or lid used as the container base, functionality would be unchanged.

What is claimed is:

1. A pill dispensing apparatus defining one element of a pill container for holding a quantity of pills, said apparatus comprising:
a base having first and second oppositely oriented funneling structures defined therein, a first opening providing a gravity fed outlet from said first funneling structure and a second opening providing a gravity fed outlet from said second funneling structure, said first funneling structure configured to open to the contained quantity of pills; and
a rotatable structure including at least a first pill acceptor for receiving a gravity fed pill through said first opening, said rotatable structure rotatably connectable with said base for moving a pill received at said pill acceptor to a position in register with said second funneling structure.

2. The apparatus of claim 1 wherein said base includes an annular side wall forming one part of each of said funneling structures, and wherein said second opening from said second funneling structure is located at said annular side wall.

3. The apparatus of claim 1 wherein said base includes an arcuate divider wall segmenting an inner volume of said base to define in part said first and second funneling structures.

4. The apparatus of claim 1 wherein said rotatable structure includes a top and a sizing collar, said sizing collar having plural pill acceptors including said first pill acceptor, different ones of said plural acceptors having one of a different shape and a different size, said sizing collar selectively positionable at said top and rotatable therewith once positioned.

5. The apparatus of claim 1 wherein said rotatable structure includes a second pill acceptor, said first and second pill acceptors positioned circumferentially opposite one another at an inner surface of said rotatable structure.

6. The apparatus of claim 5 wherein said base and said rotatable structure include cooperative position locating structure for user assurance of correct location of said pill acceptors upon rotation of said rotatable structure.

7. The apparatus of claim 1 further comprising:
said base having means for attachment to the container, said base including a catch button to prevent inadvertent rotation of said rotatable structure and a hollow first shaft; and
said rotatable structure including a sizing collar attachable to a top, said sizing collar including three slots each having a different shape or a different size and an opening permitting said sizing collar to be attached to said top, said top including a second shaft receivable through said opening in said sizing collar and at said hollow first shaft of said base, a catch system at said top functioning to engage said catch button, and a stop system at said top functioning to prevent a user from rotating said rotatable structure top beyond a predetermined amount.

8. A pill dispensing apparatus for dispensing pills from a container, said apparatus comprising:
a rotatable cover including locating means for rotatably locating said cover, and first and second pill acceptors defined at an inwardly facing surface thereof, said acceptors located oppositely one another at each side of said locating means; and
a base associated with the pill container and including an outer wall having an opening therethrough and an inner volume, said inner volume segmented to provide first and second side by side oppositely oriented funneling structures, said first funneling structure opening to the pill container and funneling to an outlet and said second funneling structure funneling to said opening through said outer wall, said base having support means associatable with said locating means of said rotatable cover for rotatably supporting said rotatable cover;
wherein said outlet from said first funneling structure is positionable adjacent to said inwardly facing surface of said rotatable cover when said locating means and support means are associated so that said outlet can be selectively brought into register with said pill acceptors when said cover is rotated.

9. The apparatus of claim 8 wherein said outer wall of said base is annular and said base further includes an arcuate dividing wall connected at said annular outer wall to segment said inner volume of said base and define said funneling structures.

10. The apparatus of claim 8 wherein said base includes a catch adjacent to said opening through said outer wall and wherein said rotatable cover includes first and second tabs adjacent to said first and second pill acceptors, capture of one of said tabs by said catch assuring proper location of one of said first and second pill acceptors at said outlet from said first funneling structure and the other of said first and second pill acceptors at said second funneling structure.

11. The apparatus of claim 8 wherein said rotatable cover includes an outer circumferential wall around said inwardly facing surface and wherein said outer wall of said base is annular, said annular outer wall of said base and said circumferential wall of said cover being receivable adjacent to one another in a nested relationship.

12. The apparatus of claim 11 wherein said pill acceptors are detents at said inner surface bounded by said circumferential wall.

13. The apparatus of claim 8 wherein said locating means includes a shaft having a retainer at an end thereof and wherein said support means includes a hollow shaft having a support shoulder at one end thereof, said shaft of said locating means receivable through said hollow shaft and held by said retainer at said shoulder.

14. The apparatus of claim 8 wherein said apparatus is configured as a cap element of the pill container.

15. A pill dispensing method for dispensing pills through an element of a pill container that holds a quantity of pills, said method comprising the steps of:
inverting the pill container so that the element is located below the quantity of pills;
funneling pills to a pill acceptor;
rotating the pill acceptor having a pill therein to a drop location;
turning the pill container to an upright position so that the pill drops from the pill acceptor; and
funneling the dropped pill to an outlet opening at a side of the element.

16. The method of claim 15 wherein the step of funneling pills to a pill acceptor includes the step of funneling pills to an outlet in register with the pill acceptor.

17. The method of claim 16 further comprising rotating the pill acceptor to a position in register with the outlet.

18. The method of claim 16 further comprising assuring location of said pill acceptor relative to said outlet.

19. The method of claim 15 further comprising user selection of one of size and shape of the pill acceptor.

20. The method of claim 15 further comprising segmenting an annular volume of the element to form side by side oppositely oriented funneling structures, and wherein the funneling steps include funneling the pills at one funneling structure and funneling the dropped pill at the other funneling structure.
